(19) United States
(12) Patent Application Publication
(10) Pub. No.: US 2003/0119566 A1
(43) Pub. Date: Jun. 26, 2003

(54) Hand-free device equipped with expansion function modules

(75) Inventor: Tonny Chen, Chang-Hua (TW)

Correspondence Address: BRUCE H. TROXELL, SUITE 1404, 5205 LEESBURG PIKE, FALLS CHURCH, VA, 22041, US

(73) Assignee: E-Lead Electronic Co., Ltd.

(21) Appl. No.: 10/025,874

(22) Filed: Dec. 26, 2001

(51) Int. Cl. H04M 1/00

(52) U.S. Cl. 455/569; 455/557

(57) ABSTRACT

A hand-free device equipped with expansion function modules allows a basic hand-free handset to attach expansion function modules depending on users' requirements so that the existing hand-free handset can be upgraded to equip additional or new function without obsolete. The invention consists of a hand-free main body and externally connected expansion function modules of various function desired. The function may be selected based on users' requirements such as GPS, PDA enabling, or audio control dialing, etc.

### BACKGROUND OF THE INVENTION

1. Field of the Invention

The invention relates to a hand-free device that equips with expansion function modules and particularly a hand-free handset that has basic hand-free capability and is allowed to add expansion function modules to include additional function based on users' requirements to avoid mobile phones or m hand-free handsets from obsolete because of lack of certain function.

2. Description of the Prior Art

Mobile phones have become very popular in many countries around the world nowadays. Hand-free handset is a widely used peripheral device for mobile phones and in many countries also becomes an essential gadget in the cars under government regulations. In recent years, mobile phones and hand-free handsets have also become fashionable products. New function and enhancements have been added and updated at a very fast pace. As a result, mobile phones or hand-free handsets tend to become obsolete whenever there is new function or feature introduced and marketed. As the inherent function of the mobile phone or hand-free handset are set and built-in in the plant, once shipped, they cannot be altered or upgraded. For instance, there are new function of adding mobile phone extension, PDA, electronic telephone directory, access the Internet, audio control, etc. When consumers want to enjoy these new function, they often have to throw away the old mobile phones or hand-free handsets. It is a huge waste of resources.

### SUMMARY OF THE INVENTION

In view of aforesaid disadvantages, it is therefore a primary object of the invention to provide a hand-free handset that includes a hand-free main body which may attach optional and selected expansion function modules (such as GPS function, PDA function or audio dialing function or the like) so that users can add various expansion function modules whenever desired without replacing the existing mobile phones or hand-free handsets.

By means of the invention, users can add additional expansion function modules on the hand-free handsets depending on their different requirements so that users can enjoy new and expanded function on the old or existing hand-free handsets.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural block diagram of an embodiment of the invention.

FIG. 2 is a schematic block diagram of an embodiment of the invention.

FIG. 3 is a block diagram of an embodiment of the invention for upgrading to equip car phone function.

FIG. 4 is a block diagram of an expansion function module of the invention.

FIG. 5 is a schematic block diagram of an expansion function module of the invention for upgrading to equip car phone function.

### DESCRIPTION OF THE PREFERRED EMBODIMENTS

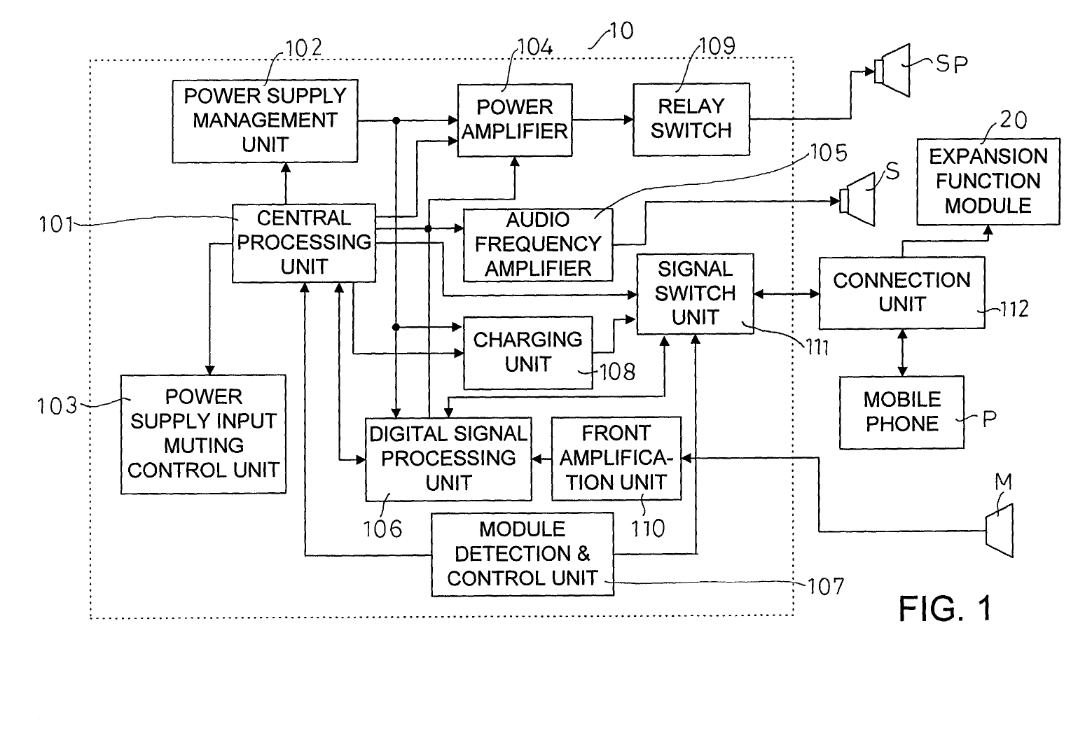

Referring to FIG. 1 for an embodiment of the invention that has a hand-free main body 10 externally attached to an expansion function module 20 of various function, the hand-free main body 10 consists of a central processing unit 101, a power supply management unit 102, a power supply input muting control unit 103, a power amplifier 104, an audio frequency amplifier 105, a digital signal processing unit 106, a module detection and control unit 107, a charging unit 108, a relay switch 109, a front amplification unit 110, a signal switch unit 111, and a connection unit 112.

The central processing unit 101 controls operations of all units in the device.

The power supply management unit 102 is controlled by the central processing unit 101 for selecting different power supply (such as battery or car electric power).

The power supply input muting control unit 103 is controlled by the central processing unit 101 for controlling car audio device to cut off power supply or switch to a muting condition.

The power amplifier 104 is controlled by the central processing unit 101 for processing and amplifying signals output by the digital signal processing unit 106.

The audio frequency amplifier 105 is controlled by the central processing unit 101 for amplifying audio signals output by the digital signal processing unit 106 and delivering to an earphone S for output.

The digital signal processing unit 106 processes input audio source (such as eliminate echo voice, noise processing, etc.)

The module detection and control unit 107 detects and controls external variations of the expansion function modules, and provides the signals to the central processing unit 101.

The charging unit 108 provides desired charge voltage and current output to mobile phones of different brands.

The relay switch 109 links to car audio device output and car audio device speakers, and switches circuits of different audio outputs.

The front amplification unit 110 processes audio input from the microphone (such as amplifying the sound).

The signal switch unit 111 switches signals depending on different linking expansion function modules.

The connection unit 112 has at least one set to link a mobile phone rear end signal line to an output unit 24 of the expansion function module.

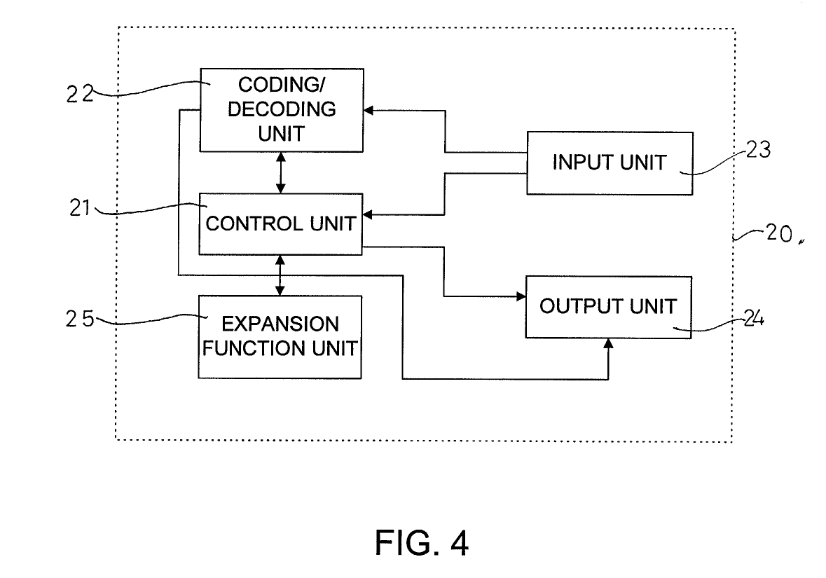

By means of the architecture and construction set forth above, the hand-free main body 10 can attach at least one expansion function module 20 (as shown in FIG. 4). Each expansion function module 20 includes at least a control unit 21, a coding/decoding unit 22, an input unit 23, an output unit 24 and an expansion function unit 25.

The control unit 21 controls and coordinates operations of the expansion function module 20 and outputs signals, and coordinates operations of the hand-free main body 10.

The coding/decoding unit 22 coordinates operations of the signal switch unit 111 of the hand-free main body 10 (generally conforms to RS232 communication protocol).

The input unit 23 is an input end linking to the connection unit 112 of the main body 10 to function as a human machine interface.

The output unit 24 is an output end to output information of the expansion function module (such as displaying data, sound, etc.), and may be a display device, LCD, signal line, etc.

The expansion function unit 25 contains preset expansion function data, such as GPS, audio control dialing, PDA, infrared light transmission, car phone, etc.

By means of aforesaid construction, the hand-free main body 10 can connect respectively through the connection unit 112 to a mobile phone P and the input unit 23 of the expansion function module 20. Then the hand-free handset can equip additional function provided by the expansion function module 20 (such as upgrade the mobile phone P to equip GPS function when the expansion function module 20 is a GPS device; or equip the mobile phone P with audio control dialing capability when the expansion function module 20 has audio control dialing function thereby to overcome the deficiency of no audio control dialing function of the original hand-free).

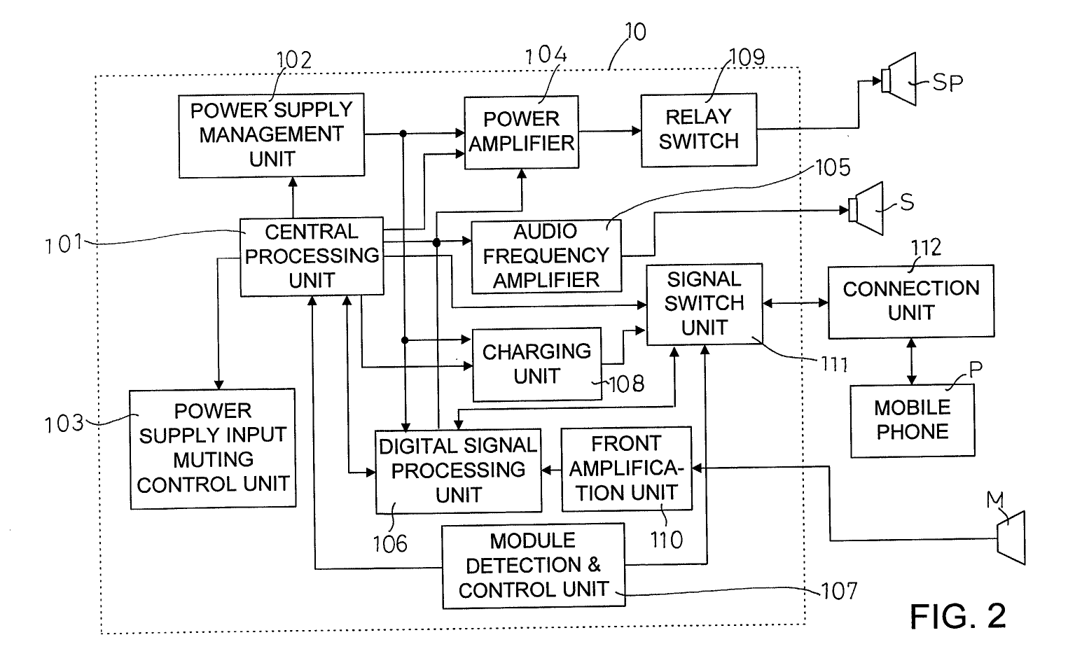

Referring to FIG. 2 for an embodiment of the invention linking to a mobile phone without the expansion function module, and with the mobile phone receiving incoming telephone calls and delivering audio output through the speaker of the car audio device. When in use, one end of the mobile phone signal line is plugged in the mobile phone P and another end of the signal line is plugged in the connection unit 112 of the invention 10. The central processing unit 101 outputs control signals to the charging unit 108 for outputting desired voltage to the mobile phone P for operation and charging. When the mobile phone P receives an incoming phone call, through the signal line and the linked connection unit 112, the central processing unit 101 is notified. Then through the power supply input muting control unit 103, the car audio device is turned off or switched to a silence state. And through the relay switch 109, the input of the speaker SP of the car audio device is switched to the invention so that user's conversation may be output through the speaker SP, and the microphone M may be used for entering input voice to do conversation.

Thus by means of the invention users may base on their requirements to add at least one expansion function module of various function to upgrade the original hand-free main body or mobile phone to equip additional function not available originally.

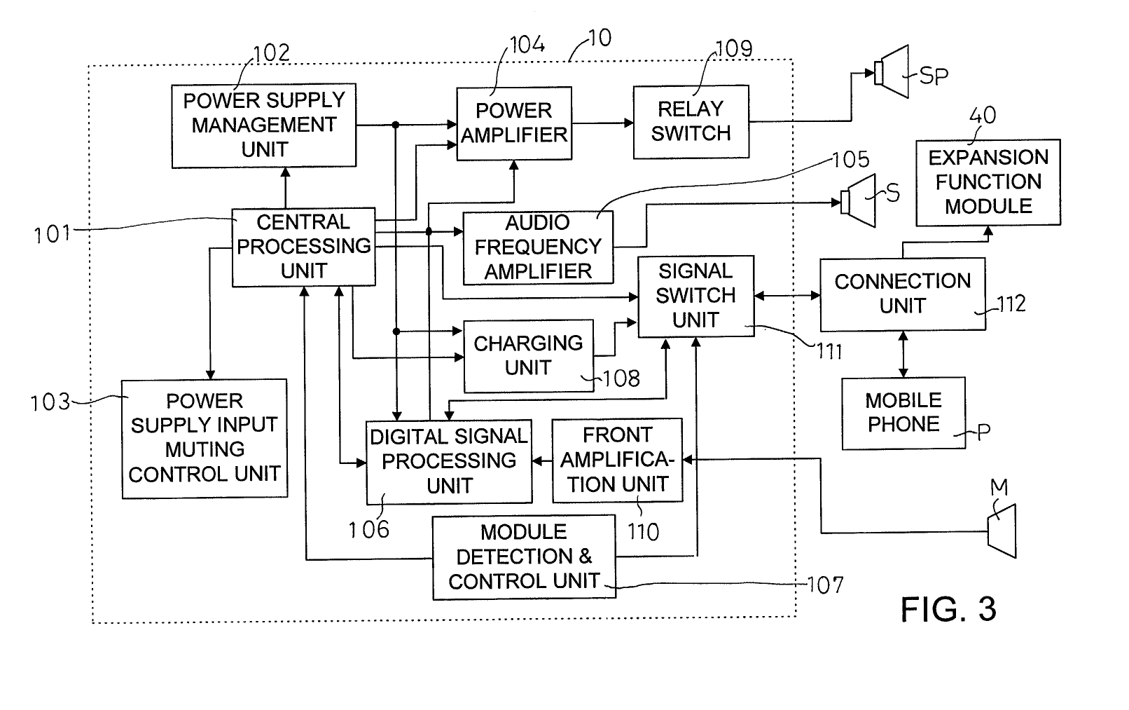

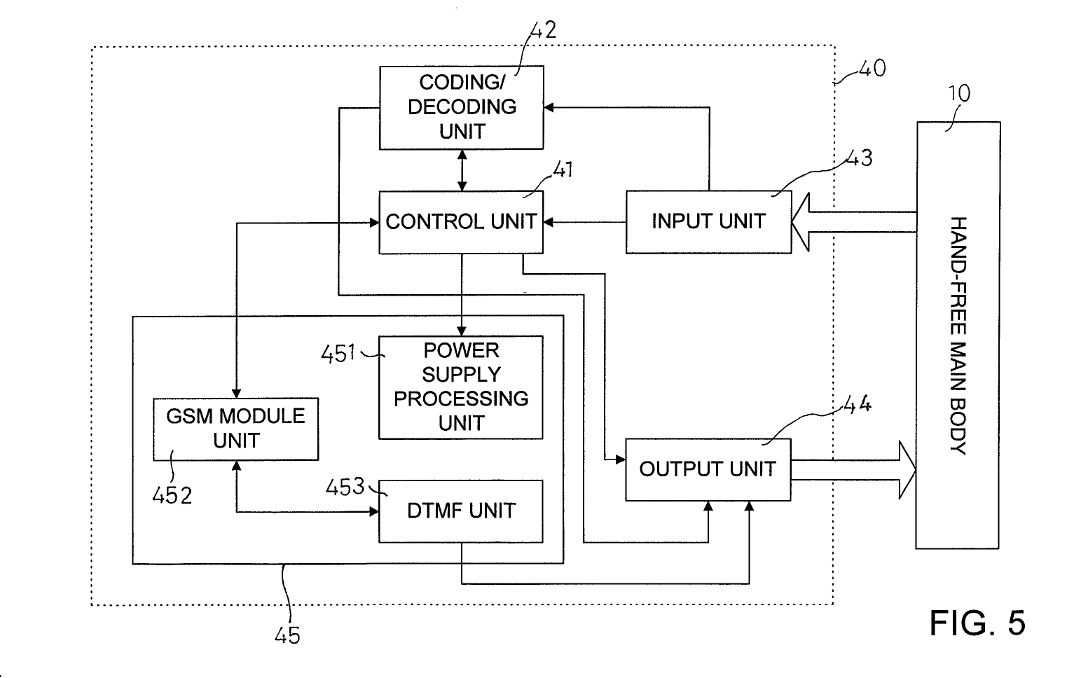

FIGS. 3 and 5 illustrate another embodiment of the invention for linking a car phone expansion function module 40 to equip the hand-free main body 10 with car phone function. The car phone expansion function module 40 consists of a control unit 41, a coding/decoding unit 42, an input unit 43, an output unit 44 and an expansion function unit 45.

The control unit 41 controls and coordinates operations of the car phone expansion function module 40 and outputs signals, and coordinates operations with the hand-free main body 10.

The coding/decoding unit 42 matches operations and coordination of the signal switch unit 111 of the hand-free main body 10.

The input unit 43 is an input end linking to the connection unit 112 of the main body 10.

The output unit 44 is an output end to output dialing and conversation information for the expansion function module 40.

The expansion function unit 45 has car phone expansion function and includes:

a power supply processing unit 451 for controlling power supply of the expansion function module 40,

a GSM module unit 452 which is a communication module matching mobile phone chips; and

a DTMF unit 453 to allow the expansion function unit 45 dialing telephone through audio frequency.

When attaching the car phone expansion function module 40 to the hand-free main body 10, users may insert the mobile phone chips supplied by the mobile phone service providers in the GSM module 452, then the hand-free hand set of the invention can equip car phone function, and can avoid the mobile phone connection line matching specification problem that might otherwise happen. When in use, the module detection and control unit 107 may detect output signals from the output unit 44 of the car phone expansion function module 40, and notify the central processing unit 101 to output control (or matching) signals so that users may use the input unit 43 to activate dialing or receiving the incoming call. And the expansion function module 40 can communicate with the hand-free main body 10 through the output unit 44, input unit 43 and connection unit 112 (including output/input voice, control signals, etc.).

By means of the hand-free device equipped with expansion function modules of the invention set forth above, users may freely configure expansion function modules of different function depending on their requirements to allow communication products constantly upgrade and function as desired without obsolete because of fashion changes.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A hand-free device equipped with expansion function modules comprising a hand-free main body and at least one connection unit for connecting at least one expansion function module, wherein:
the hand-free main body includes a module detection and control unit for detecting external variations of the expansion function module and controlling the expansion function module, and providing signals to a central processing unit, and through a signal switch unit to perform signal switching for the connected different expansion function modules; and
the expansion function module includes at least:
a control unit for controlling and coordinating operations of the expansion function module and outputting signals, and coordinating operations of the hand-free main body;
a coding/decoding unit for matching operations and coordination of the signal switch unit of the hand-free main body;
an input unit serving as an input end for linking to the connection unit of the hand-free main body;
an output unit serving as an output end to output information of the expansion function module; and
an expansion function unit containing preset expansion function data.

2. The hand-free device equipped with expansion function modules of claim 1, wherein the input unit is a signal line.

3. The hand-free device equipped with expansion function modules of claim 1, wherein the input unit is a human machine interface.

4. The hand-free device equipped with expansion function modules of claim 1, wherein the output unit is a display device.

5. The hand-free device equipped with expansion function modules of claim 1, wherein the output unit is a signal line.

6. The hand-free device equipped with expansion function modules of claim 1, wherein the output unit is a LCD.

7. The hand-free device equipped with expansion function modules of claim 1, wherein the preset expansion function data contained in the expansion function unit are selectively for GPS, audio control, or car phone.

8. The hand-free device equipped with expansion function modules of claim 7, wherein the preset expansion function data contained in the expansion function unit are for car phone function, and the expansion function unit including a power supply management unit for controlling power supply for the expansion function module, a GSM module unit for matching communication modules of mobile phone chips, and a DTMF unit to allow the expansion function unit dialing telephone through audio frequency.
